(19) United States
(12) Patent Application Publication
(10) Pub. No.: US 2025/0007210 A1
(43) Pub. Date: Jan. 2, 2025

(54) Connector and Connector Assembly

(71) Applicants: Tyco Electronics Technology (SIP) Co., Ltd., Suzhou (CN); Tyco Electronics (Shanghai) Co., Ltd., Shanghai (CN)

(72) Inventors: Liwei Zou, Suzhou (CN); Jianjia Qi, Shanghai (CN); Feng (Carlos) Pan, Suzhou (CN)

(73) Assignees: Tyco Electronics Technology (SIP) Co., Ltd., Suzhou (CN); Tyco Electronics (Shanghai) Co., Ltd., Shanghai (CN)

(21) Appl. No.: 18/756,796

(22) Filed: Jun. 27, 2024

(30) Foreign Application Priority Data
Jun. 27, 2023 (CN) 202310763581.3

(51) Int. Cl. H01R 13/627; H01R 13/506; H01R 13/631

(52) U.S. Cl. CPC H01R 13/627; H01R 13/506; H01R 13/631

(57) ABSTRACT

A connector comprises an outer conductor, an insulator, and a central terminal. The outer conductor includes an upper outer conductor and a lower outer conductor. The insulator is provided in the outer conductor and includes an upper insulator and a lower insulator. The central terminal is arranged in the insulator. The upper insulator and the lower insulator are assembled together in a sliding fit, allowing the upper insulator to move relative to the lower insulator. The upper outer conductor and the lower outer conductor are movably engaged together, allowing the upper outer conductor to move together with the upper insulator.

### CROSS-REFERENCE TO RELATED APPLICATION

This application claims the benefit of Chinese Patent Application No. CN202310763581.3 filed on Jun. 27, 2023 in the State Intellectual Property Office of China, the whole disclosure of which is incorporated herein by reference.

### FIELD OF THE INVENTION

Embodiments of the present disclosure generally relate to a connector and a connector assembly comprising the connector.

### BACKGROUND

In the prior art, a coaxial connector typically includes an outer conductor, an insulator placed in the outer conductor, and a central terminal placed in the insulator. Multiple elastic cantilevers are formed on the outer conductor, which are used to establish electrical contact with the inner wall of the outer conductor of the mating connector. The central terminal has an elastic contact part, which makes electrical contact with the mating terminal of the mating connector.

In the prior art, when there is a significant radial deviation between the coaxial connector and the mating connector, the central terminal and the elastic cantilever of the outer conductor of the connector will be offset to one side under the pushing of the mating connector to absorb the radial deviation between the coaxial connector and the mating connector, ensuring reliable electrical contact between the two. However, in the prior art, when there is a significant radial deviation between the coaxial connector and the mating connector, the elastic cantilever of the outer conductor of the connector will be subjected to significant bias pressure. This may cause plastic deformation of the elastic cantilever of the outer conductor. In addition, in order to ensure that the central terminal can be offset in the insulator, it is necessary to form a larger inner cavity in the insulator, which will increase the volume of the insulator, leading to an increase in the volume of the entire connector, which is not conducive to the miniaturization of the connector.

### SUMMARY

According to an embodiment of the present disclosure, a connector includes an outer conductor, an insulator, and a central terminal. The outer conductor includes an upper outer conductor and a lower outer conductor. The insulator is provided in the outer conductor and includes an upper insulator and a lower insulator. The central terminal is arranged in the insulator. The upper insulator and the lower insulator are assembled together in a sliding fit, allowing the upper insulator to move relative to the lower insulator. The upper outer conductor and the lower outer conductor are movably engaged together, allowing the upper outer conductor to move together with the upper insulator.

### BRIEF DESCRIPTION OF THE DRAWINGS

The invention will now be described by way of example with reference to the accompanying Figures, of which:

FIG. 1 shows an illustrative perspective view of a connector according to an exemplary embodiment of the present invention;

FIG. 2 shows an illustrative axial sectional view of a connector according to an exemplary embodiment of the present invention;

FIG. 3 shows an illustrative exploded view of a connector according to an exemplary embodiment of the present invention;

FIG. 4 shows an illustrative exploded sectional view of a connector according to an exemplary embodiment of the present invention;

FIG. 5 shows an illustrative axial sectional view of the insulator of a connector according to an exemplary embodiment of the present invention;

FIG. 6 shows an illustrative exploded sectional view of the insulator of a connector according to an exemplary embodiment of the present invention;

FIG. 7 shows an illustrative axial sectional view of the insulator and central terminal of a connector according to an exemplary embodiment of the present invention;

FIG. 8 shows an illustrative perspective view of the central terminal of a connector according to an exemplary embodiment of the present invention;

FIG. 9 shows an illustrative axial sectional view of the central terminal of a connector according to an exemplary embodiment of the present invention;

FIG. 10 shows an illustrative exploded sectional view of the outer conductor of a connector according to an exemplary embodiment of the present invention;

FIG. 11 shows an illustrative section view of the assembly of the outer conductor of a connector according to an exemplary embodiment of the present invention;

FIG. 12 shows an illustrative axial sectional view of a connector assembly according to an exemplary embodiment of the present invention, where there is no radial deviation between the connector and the mating connector; and

FIG. 13 shows an illustrative axial sectional view of a connector assembly according to an exemplary embodiment of the present invention, where there is a significant radial deviation between the connector and the mating connector.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a connector includes an outer conductor having an upper outer conductor and a lower outer conductor, an insulator provided in the outer conductor and including an upper insulator and a lower insulator, and a central terminal provided in the insulator. The upper insulator and the lower insulator are assembled together in a sliding fit, allowing the upper insulator to move relative to the lower insulator. The upper outer conductor and the lower outer conductor are movably engaged together, allowing the upper outer conductor to move together with the upper insulator.

According to another embodiment, a connector assembly comprises the above connector; and a mating connector mated with the connector. The mating connector comprises a mating outer conductor mated with the upper outer conductor of the connector, and a mating terminal provided in the mating outer conductor for mating with the center terminal of the connector.

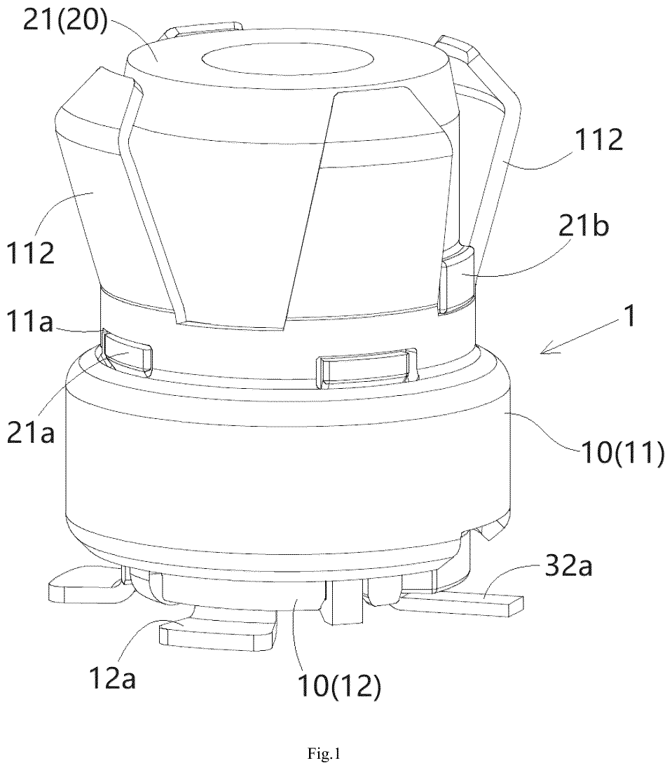

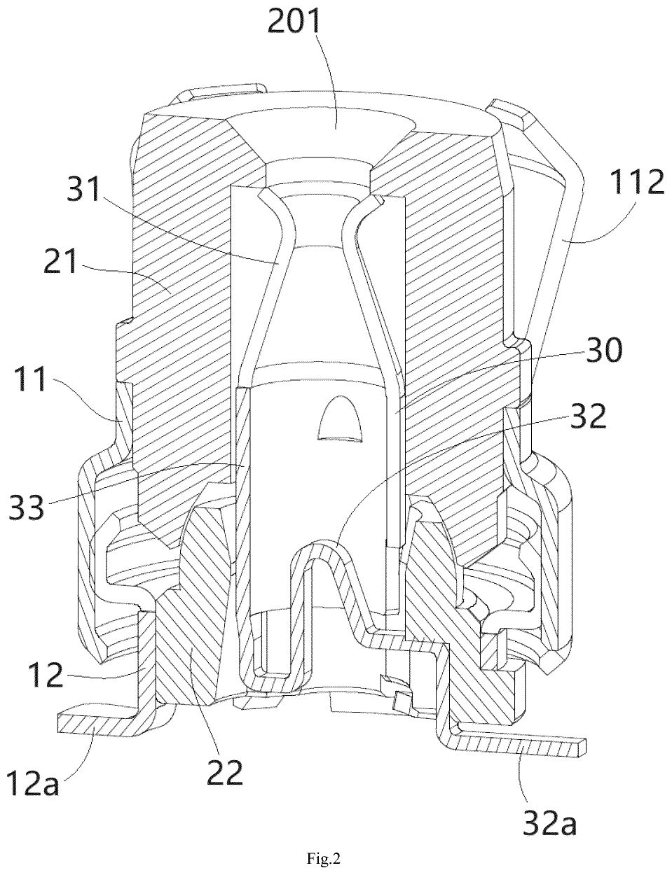

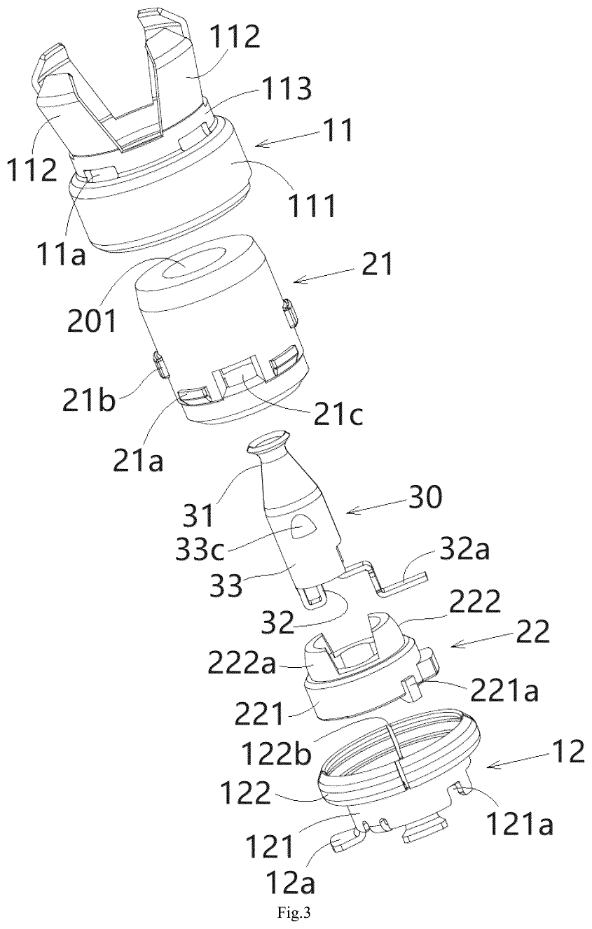

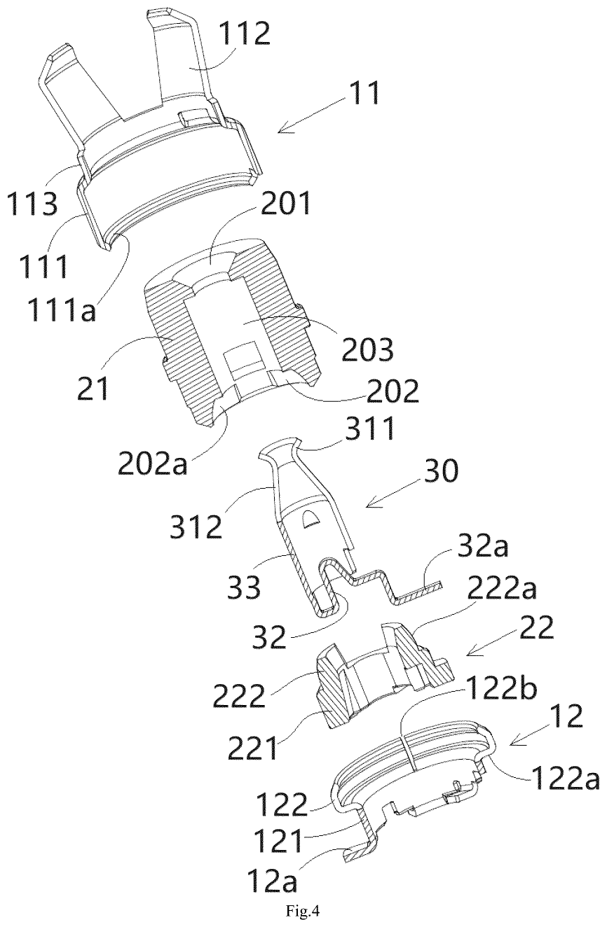

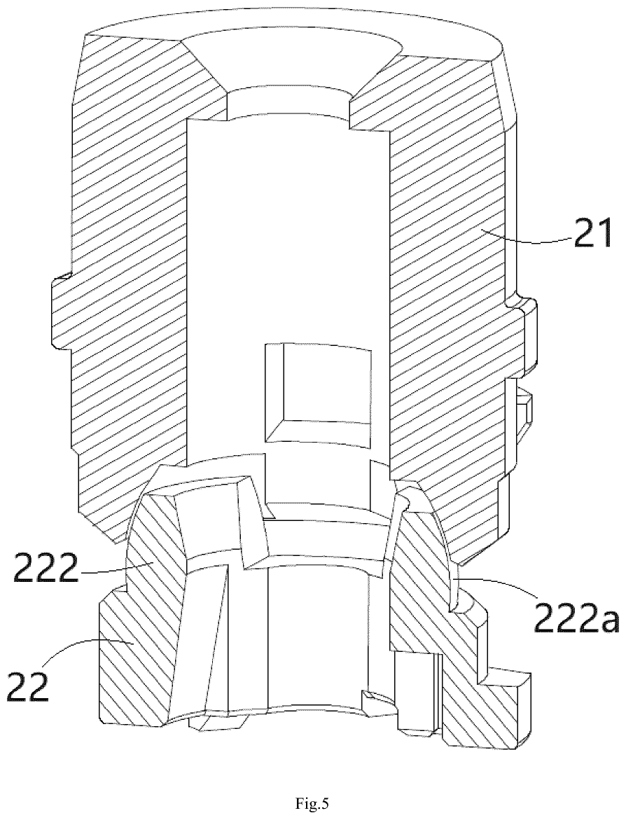

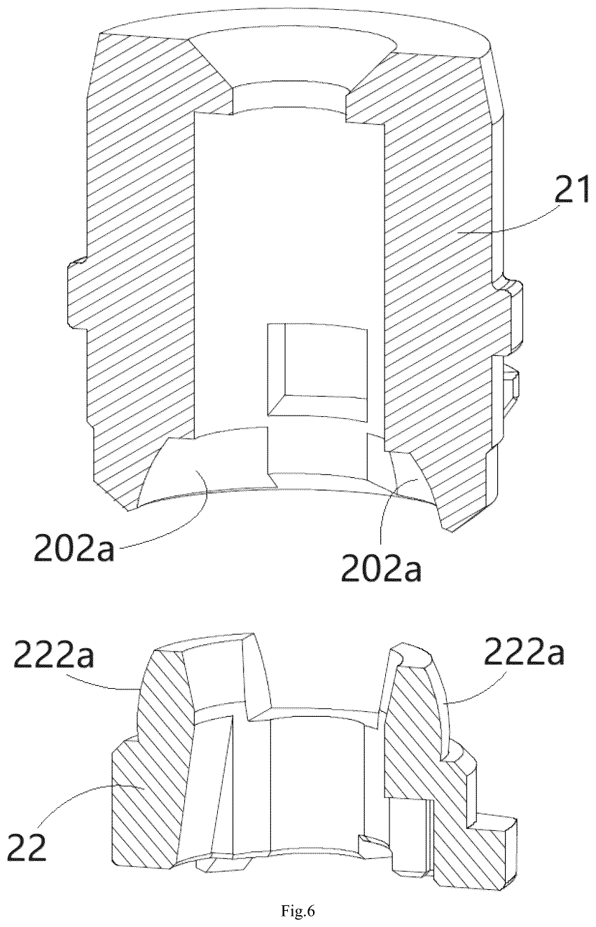

FIG. 1 shows an illustrative perspective view of connector 1 according to an exemplary embodiment of the present invention. FIG. 2 shows an illustrative axial sectional view of connector 1 according to an exemplary embodiment of the present invention. FIG. 3 shows an illustrative exploded view of connector 1 according to an exemplary embodiment of the present invention. FIG. 4 shows an illustrative exploded sectional view of connector 1 according to an exemplary embodiment of the present invention. FIG. 5 shows an illustrative axial sectional view of the insulator 20 of connector 1 according to an exemplary embodiment of the present invention. FIG. 6 shows an illustrative exploded sectional view of the insulator 20 of a connector according to an exemplary embodiment of the present invention.

As shown in FIGS. 1-6, in an exemplary embodiment of the present disclosure, a connector 1 is disclosed. The connector 1 mainly includes an outer conductor 10, an insulator 20, and a central terminal 30. The outer conductor 10 includes an upper outer conductor 11 and a lower outer conductor 12. The insulator 20 is arranged in the outer conductor 10 and includes an upper insulator 21 and a lower insulator 22. The central terminal 30 is set in the insulator 20.

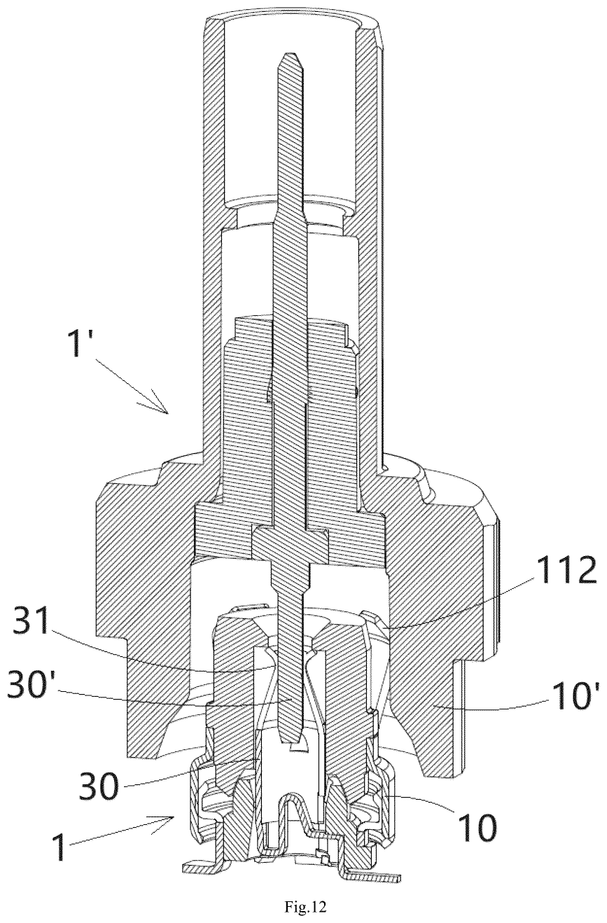

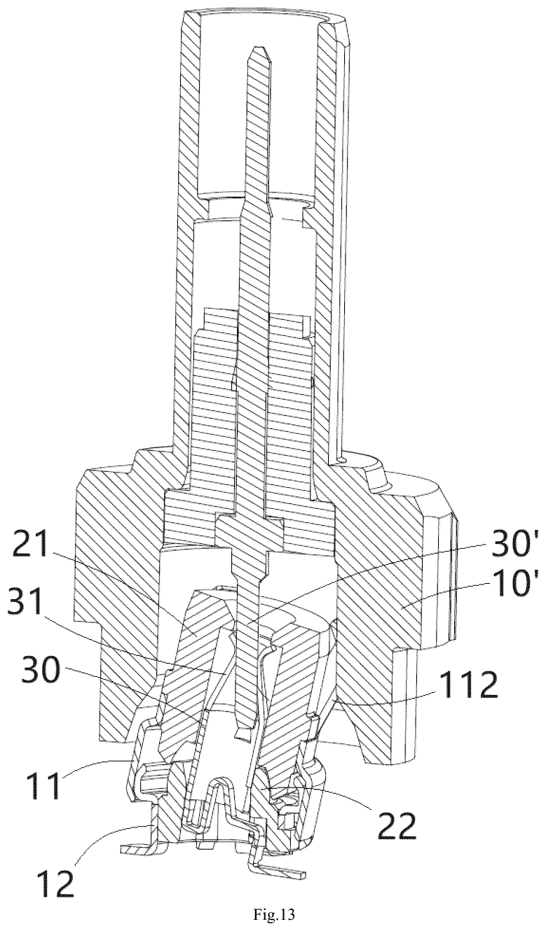

FIG. 12 shows an illustrative axial sectional view of a connector assembly according to an exemplary embodiment of the present invention, where there is no radial deviation between connector 1 and mating connector 1′. FIG. 13 shows an illustrative axial sectional view of a connector assembly according to an exemplary embodiment of the present invention, where there is a significant radial deviation between connector 1 and mating connector 1′.

As shown in FIGS. 1-6, 12 and 13, in the illustrated embodiments, the upper insulator 21 and the lower insulator 22 are assembled together in a sliding fit, allowing the upper insulator 21 to move relative to the lower insulator 22. In the illustrated embodiment, the upper insulator 21 and the lower insulator 22 are assembled together in a spherical fit, allowing the upper insulator 21 to rotate around a sphere center relative to the lower insulator 22. However, the present invention is not limited to the illustrated embodiments. For example, the upper insulator 21 and the lower insulator 22 can also be assembled together in an arc-shaped fit, allowing the upper insulator 21 to slide relative to the lower insulator 22.

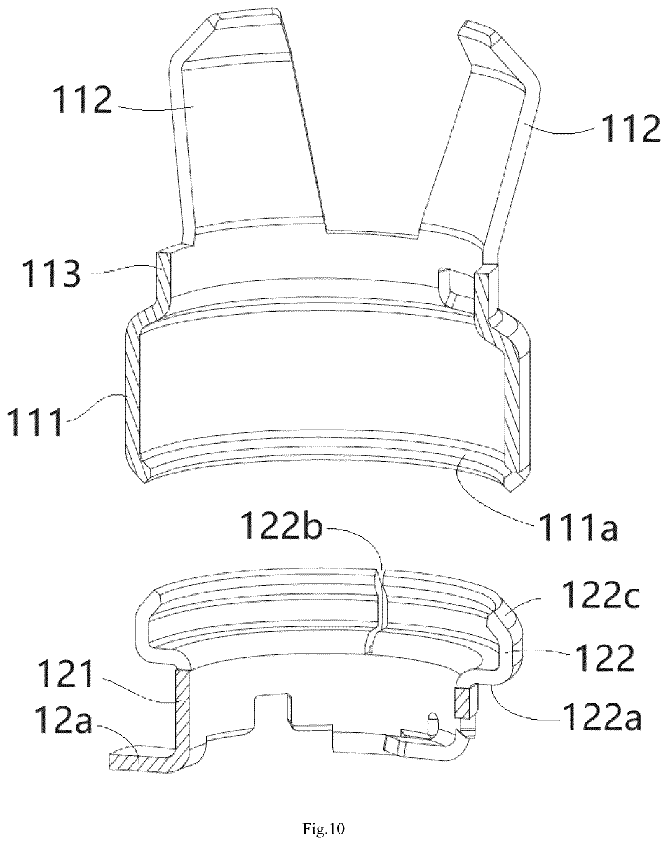

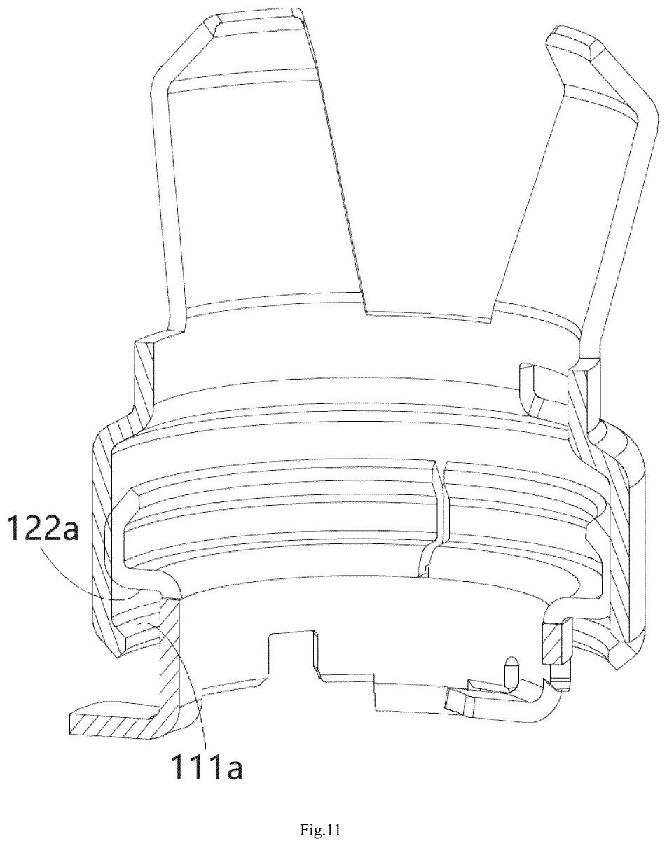

FIG. 10 shows an illustrative exploded sectional view of the outer conductor 10 of connector 1 according to an exemplary embodiment of the present invention. FIG. 11 shows an illustrative section view of the assembly of the outer conductor 10 of connector 1 according to an exemplary embodiment of the present invention.

As shown in FIGS. 1-6 and 10-13, in the illustrated embodiments, the upper outer conductor 11 and the lower outer conductor 12 are movably engaged together, allowing the upper outer conductor 11 to rotate around the same sphere center together with the upper insulator 21. The upper insulator 21 has a lower port 202, the lower insulator 22 has an upper end 222, and the upper end 222 of the lower insulator 22 is inserted into the lower port 202 of the upper insulator 21. The lower port 202 of the upper insulator 21 has a spherical inner surface 202a, the upper end 222 of the lower insulator 22 has a spherical outer surface 222a, and the spherical inner surface 202a is fitted with the spherical outer surface 222a. In this way, the upper insulator 21 can rotate relative to the lower insulator 22 around the center of the spherical inner surface 202a and the spherical outer surface 222a.

The upper outer conductor 11 comprises a cylinder body portion 111 and multiple elastic arms 112. The cylinder body portion 111 has an upper end and a lower end that are axially opposite to each other. Multiple elastic arms 112 are connected to the upper end of the cylinder body portion 111 and evenly spaced around the cylinder body portion 111. The lower end of the cylinder body portion 111 is movably engaged to the lower outer conductor 12, and the elastic arm 112 is used for electrical contact with a mating outer conductor 10′ of a mating connector 1′. The upper outer conductor 11 and the upper insulator 21 are kept together to ensure that they can rotate around the same sphere center together.

The cylinder body portion 111 has a neck 113 located at its upper end. The roots of multiple elastic arms 112 are connected to the upper periphery of the neck 113. A first snap slot 11a is formed on the neck 113, and a first protrusion 21a is formed on the upper insulator 21, which is engaged in the first snap slot 11a. In the illustrated embodiments, a second protrusion 21b is also formed on the upper insulator 21, the second protrusion 21b is clamped between the roots of adjacent elastic arms 112 and pressed against the upper periphery of the neck 113.

The lower outer conductor 12 comprises a cylindrical portion 121, a flange portion 122, and a welding portion 12a. The cylindrical portion 121 has upper and lower ends opposite to each other in its axial direction. The flange portion 122 is connected to the upper end of the cylindrical portion 121. The welding portion 12a is connected to the lower end of the cylindrical portion 121 for welding to a circuit board (not shown).

The flange portion 122 is annular and protrudes outward relative to the outer circumference of the cylindrical portion 121. The flange portion 122 is inserted into the lower end of the cylinder body portion 111. The outer surface of the flange portion 122 is in interference fit with the inner wall surface of the lower end of the cylinder body portion 111 to ensure that the cylinder body portion 111 can always maintain electrical contact with the flange portion 122 when the upper outer conductor 11 is rotated. A flipped edge portion 111a is formed at the lower end of the cylinder body portion 111. The flipped edge portion 111a is curled inward and suitable for pressing against the bottom 122a of the flange portion 122 to prevent the cylinder body portion 111 from being detached from the flange portion 122 when the upper outer conductor 11 is rotated.

Multiple longitudinally extending dividing slits 122b are formed on the flange portion 122, and the multiple dividing slits 122b are spaced around the flange portion 122. In this way, the flange portion 122 is divided into multiple cantilevers. A conical guide slope 122c is formed on the flange portion 122. The guide slope 122c is adapted to guide the flange portion 122 into the lower end of the cylinder body portion 111.

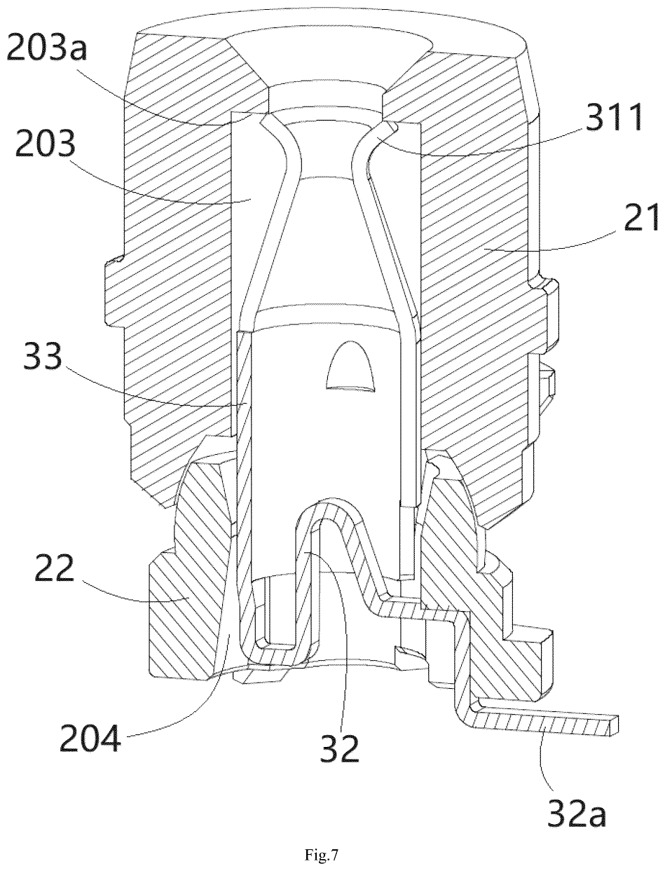

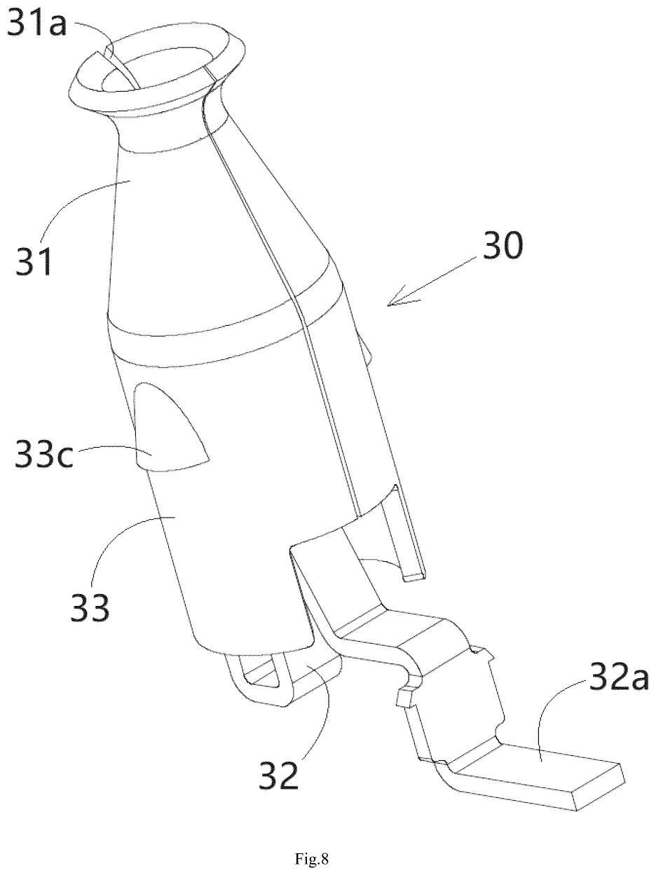

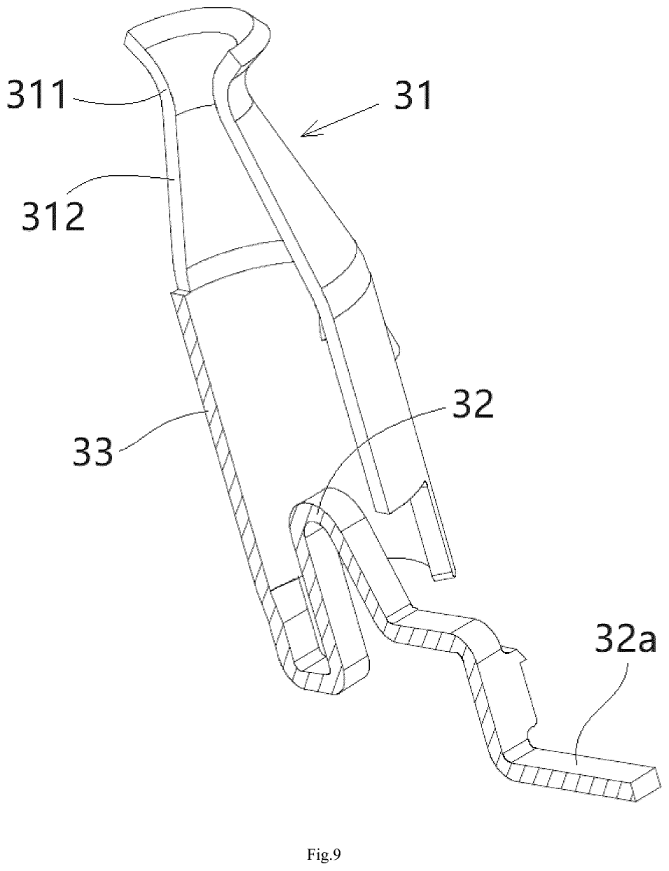

FIG. 7 shows an illustrative axial sectional view of the insulator 20 and central terminal 30 of a connector according to an exemplary embodiment of the present invention. FIG. 8 shows an illustrative perspective view of the central terminal 30 of a connector according to an exemplary embodiment of the present invention. FIG. 9 shows an illustrative axial sectional view of the central terminal 30 of a connector according to an exemplary embodiment of the present invention.

As shown in FIGS. 1-13, the lower insulator 22 has a cylindrical base 221, and the outer peripheral surface of the cylindrical base 221 is in interference fit with the inner peripheral surface of the cylindrical portion 121 of the lower outer conductor 12 to keep the lower outer conductor 12 and the lower insulator 22 together. A positioning slot 121a is formed on the lower periphery of the cylindrical portion 121 of the lower outer conductor 12, and a positioning protrusion 221a is formed on the cylindrical base 221 of the lower insulator 22. The positioning protrusion 221a is matched with the positioning slot 121a.

The central terminal 30 comprises a main body 33, an elastic contact portion 31, and an elastic connection part 32. The main body 33 is cylindrical and has upper and lower ends opposite to each other in its axial direction. The elastic contact portion 31 is connected to the upper end of the main body 33 for electrical contact with the mating terminal 30′ of the mating connector 1′. One end of the elastic connection part 32 is connected to the lower periphery of the main body 33, and the other end 32a is used for soldering to the circuit board. The upper part of the main body 33 is retained in the upper insulator 21, allowing the central terminal 30 to rotate around the sphere center together with the upper insulator 21.

An upper accommodating hole 203 is formed in the upper insulator 21. The elastic contact part 31 and the upper part of the main body 33 of the center terminal 30 are accommodated in the upper accommodating hole 203. The outer diameter of the main body 33 is equal to or slightly smaller than the inner diameter of the upper accommodating hole 203, so that there is no gap or a gap smaller than a predetermined value between the outer peripheral surface of the main body 33 and the inner peripheral surface of the upper accommodating hole 203. In this way, the volume of the upper insulator 21 and the entire connector 1 can be reduced, especially the radial size of the entire connector 1 can be reduced.

A lower accommodating hole 204 is formed in the lower insulator 22. The elastic connection part 32 and the lower part of the main body 33 of the center terminal 30 are accommodated in the lower accommodating hole 204. The inner diameter of the lower accommodating hole 204 is greater than the outer diameter of the main body 33 to allow the lower part of the main body 33 to swing radially in the lower accommodating hole 204, thereby allowing the central terminal 30 to rotate together with the upper insulator 21. The elastic connection part 32 has at least one bending segment located between its two ends, allowing the elastic connection part 32 to deform from an initial state (as shown in FIG. 12) to another state different from the initial state (such as the state shown in FIG. 13) when the center terminal 30 is rotated together with the upper insulator 21.

A protrusion 33c is formed on the main body 33 of the central terminal 30. A slot 21c is formed on the upper insulator 21. The protrusion 33c is engaged with the slot 21c to maintain the main body 33 in the upper insulator 21.

The elastic contact portion 31 of the center terminal 30 comprises a trumpet shaped end portion 311 and a conical connection portion 312. The conical connection portion 312 is connected between the trumpet shaped end portion 311 and the main body 33. The trumpet shaped end portion 311 is used to guide the insertion of the mating terminal 30′ and to make electrical contact with the inserted mating terminal 30′. The diameter of the conical connection portion 312 gradually increases from the trumpet shaped end portion 311 towards the main body 33.

Multiple axial dividing slits 31a are formed on the elastic contact portion 31 of the center terminal 30. The multiple axial dividing slits 31a are spaced in the circumferential direction of the elastic contact portion 31. As a result, the elastic contact portion 31 is divided into multiple elastic cantilevers.

A trumpet shaped guide inlet 201 is formed on the upper end face of the upper insulator 21 and splayed outward. The minimum inner diameter of the trumpet shaped guide inlet 201 is equal to the maximum inner diameter of the trumpet shaped end portion 311. The inner diameter of the trumpet shaped guide inlet 201 gradually increases from the trumpet shaped end portion 311 upwards to guide the mating terminal 30′ into the elastic contact part 31 of the center terminal 30. A positioning step 203a is formed in the upper insulator 21, and the trumpet shaped end portion 311 is axially pressed against the positioning step 203a to position the center terminal 30 axially.

In another exemplary embodiment of the present invention, a connector assembly is also disclosed. The connector assembly mainly includes a connector 1 and a mating connector 1′. The mating connector 1′ is mated with the connector 1. The mating connector 1′ includes a mating outer conductor 10′ and a mating terminal 30′. The mating outer conductor 10′ is mated with the upper outer conductor 11 of the connector 1. The mating terminal 30′ is provided in the mating outer conductor 10′ and is used for mating with the center terminal 30 of the connector 1.

The upper outer conductor 11 is inserted into the mating outer conductor 10′. The elastic arm 112 of the upper outer conductor 11 is in electrical contact with the inner wall surface of the mating outer conductor 10′. The mating terminal 30′ is into the elastic contact part 31 of the center terminal 30. The elastic contact part 31 of the center terminal 30 is in electrical contact with the mating terminal 30′.

As shown in FIG. 12, in the illustrated embodiment, there is no radial deviation between the connector 1 and the mating connector 1′. That is, the central axis of the connector 1 coincides with the central axis of the mating connector 1′. During the mating process between the mating connector 1′ and the connector 1, the upper outer conductor 11, upper insulator 21, and central terminal 30 of connector 1 will not rotate around the sphere center.

As shown in FIG. 13, there is a significant radial deviation between the connector 1 and the mating connector 1′. During the mating process between the mating connector 1′ and the connector 1, the upper outer conductor 11, upper insulator 21, and central terminal 30 of connector 1 will rotate around the sphere center to absorb the radial deviation between the connector 1 and the mating connector 1′.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A connector, comprising:
an outer conductor including an upper outer conductor movably engaged with a lower outer conductor;
an insulator provided in the outer conductor and including an upper insulator and a lower insulator, the upper insulator slidably assembled with, and movable relative to, the lower insulator, the upper outer conductor movable together with the upper insulator; and
a central terminal provided in the insulator.

2. The connector according to claim 1, wherein:
the upper insulator and the lower insulator are assembled together in a spherical fit, such that the upper insulator is rotatable around a sphere center relative to the lower insulator; and
the upper outer conductor is rotatable about the sphere center together with the upper insulator.

3. The connector according to claim 2, wherein:
the upper insulator has a lower port, the lower insulator has an upper end, and the upper end of the lower insulator is inserted into the lower port; and
the lower port has a spherical inner surface, the upper end of the lower insulator has a spherical outer surface, and the spherical inner surface is fitted with the spherical outer surface.

4. The connector according to claim 2, wherein the upper outer conductor comprises:
a cylinder body portion having an upper end and a lower end axially opposite to each other; and
multiple elastic arms connected to the upper end of the cylinder body portion and evenly spaced around the cylinder body portion, the lower end of the cylinder body portion is movably engaged with the lower outer conductor, and the elastic arms adapted to electrically contact a mating outer conductor of a mating connector.

5. The connector according to claim 4, wherein:
the upper outer conductor and the upper insulator are fixed together;
the cylinder body portion has a neck located at its upper end, and roots of the multiple elastic arms are connected to the upper periphery of the neck; and
a first snap slot is formed on the neck, and a first protrusion is formed on the upper insulator, the first protrusion is engaged in the first snap slot.

6. The connector according to claim 5, wherein a second protrusion is formed on the upper insulator and is clamped between the roots of adjacent elastic arms and pressed against the upper periphery of the neck.

7. The connector according to claim 4, wherein the lower outer conductor comprises:
a cylindrical portion having an upper end and a lower end axially opposite to each other;
a flange portion connected to the upper end of the cylindrical portion, the flange portion is annular and protrudes outward relative to the outer circumference of the cylindrical portion, the flange portion is inserted into the lower end of the cylinder body portion, an outer peripheral surface of the flange portion forms interference fit with the inner wall surface of the lower end of the cylinder body portion such that the cylinder body portion maintains in electrical contact with the flange portion when the upper outer conductor is rotated; and
a welding portion connected to the lower end of the cylindrical portion and adapted to be welded to a circuit board.

8. The connector according to claim 7, wherein a flipped edge portion is formed at the lower end of the cylinder body portion, the flipped edge portion is inward curled and abuts against the bottom of the flange portion to prevent the cylinder body portion from being detached from the flange portion when the upper outer conductor is rotated.

9. The connector according to claim 7, wherein:
multiple dividing slits axially extending are formed on the flange portion and are arranged at intervals in the circumferential direction of the flange portion for dividing the flange portion into multiple cantilevers; and
a conical guide slope is formed on the flange portion and guides the flange portion into the lower end of the cylinder body portion.

10. The connector according to claim 7, wherein:
the lower insulator has a cylindrical base, and the outer peripheral surface of the cylindrical base is in interference fit with the inner peripheral surface of the cylindrical portion of the lower outer conductor to keep the lower outer conductor and the lower insulator together;
a positioning slot is formed on the lower periphery of the cylindrical portion of the lower outer conductor; and
a positioning protrusion is formed on the cylindrical base of the lower insulator, the positioning protrusion is complementary to the positioning slot.

11. The connector according to claim 2, wherein the central terminal comprises:
a cylindrical main body having an upper end and a lower end axially opposite to each other;
an elastic contact part connected to the upper end of the main body and adapted to electrically contact the mating terminal of the mating connector; and
an elastic connection part having one end connected to the lower periphery of the main body, and another end adapted to be soldered to a circuit board, the upper part of the main body is kept in the upper insulator such that the central terminal is rotatable around the sphere center together with the upper insulator.

12. The connector according to claim 11, wherein:
an upper accommodating hole is formed in the upper insulator, and the elastic contact part and the upper part of the main body of the central terminal are accommodated in the upper accommodating hole; and
the outer diameter of the main body is equal to or smaller than the inner diameter of the upper accommodating hole, such that there is no gap or a gap smaller than a predetermined value between the outer peripheral surface of the main body and the inner peripheral surface of the upper accommodating hole.

13. The connector according to claim 11, wherein:
a lower accommodating hole is formed in the lower insulator, and the elastic connection part and the lower part of the main body of the central terminal are accommodated in the lower accommodating hole; and
an inner diameter of the lower accommodating hole is greater than an outer diameter of the main body to allow the lower part of the main body to swing radially in the lower accommodating hole, allowing the central terminal to rotate together with the upper insulator.

14. The connector according to claim 11, wherein the elastic connection part has at least one bending segment located between its two ends, the bending segment enabling the elastic connection part to deform from an initial state to another state different from the initial state when the central terminal is rotated together with the upper insulator.

15. The connector according to claim 11, wherein a protrusion is formed on the main body of the central terminal, and a slot is formed on the upper insulator, the protrusion is engaged with the slot and maintaining the main body in the upper insulator.

16. The connector according to claim 11, wherein the elastic contact part of the central terminal comprises:
a trumpet shaped end portion adapted to guide the insertion of the mating terminal and electrical contact with the inserted mating terminal; and
a conical connection portion which is connected between the trumpet shaped end portion and the main body, a diameter of the conical connection portion gradually increases from the trumpet shaped end portion towards the main body.

17. The connector according to claim 16, wherein multiple axial dividing slits are formed on the elastic contact part of the central terminal and arranged at intervals in the circumferential direction of the elastic contact part for dividing the elastic contact part into multiple elastic cantilevers.

18. The connector according to claim 16, wherein:
a trumpet shaped guide inlet is formed on the upper end face of the upper insulator and is splayed outward, a minimum inner diameter of the trumpet shaped guide inlet is equal to a maximum inner diameter of the trumpet shaped end portion; and
the inner diameter of the trumpet shaped guide inlet gradually increases upwards from the trumpet shaped end portion to guide the mating terminal into the elastic contact part of the center terminal.

19. The connector according to claim 16, wherein a positioning step is formed in the upper insulator, and the trumpet shaped end portion is axially against the positioning step to axially position the center terminal.

20. A connector assembly, comprising:
a connector, including:
an outer conductor having an upper outer conductor movably engaged with a lower outer conductor;
an insulator provided in the outer conductor and having an upper insulator and a lower insulator, the upper insulator slidably assembled with, and movable relative to, the lower insulator, the upper outer conductor movable together with the upper insulator; and
a central terminal provided in the insulator; and
a mating connector mated with the connector, including:
a mating outer conductor mated with the upper outer conductor of the connector; and
a mating terminal provided in the mating outer conductor and mating with the center terminal of the connector.
